(19) United States
(12) Patent Application Publication
(10) Pub. No.: US 2005/0202832 A1
(43) Pub. Date: Sep. 15, 2005

(54) Privacy features for a cellular telephone location identification system

(76) Inventor: Isaias Sudit, Delray Beach, FL (US)

Correspondence Address: EDWARDS & ANGELL, LLP, P.O. BOX 55874, BOSTON, MA, 02205, US

(21) Appl. No.: 11/068,219

(22) Filed: Feb. 28, 2005

Related U.S. Application Data
(60) Provisional application No. 60/553,227, filed on Mar. 15, 2004.
(60) Provisional application No. 60/553,226, filed on Mar. 15, 2004.

(51) Int. Cl. H04M 3/16; H04M 1/66

(52) U.S. Cl. 455/456.1; 455/411; 455/410

(57) ABSTRACT

A method for providing security features for a cellular phone. The method includes the step of authorizing administrator changes to location identification settings associated with the cellular phone. Location identification option selections then can be received from the administrator for the cellular phone and at least one location identification rule can be defined that is based upon the received location identification option selections. Finally, at least one security feature can be provided to prevent an unauthorized user from changing the location identification settings. The defined location identification rules can be stored in the cellular phone or in a server. Control of the location identification settings can be asserted from a centralized location remote from the cellular phone. The location identification rules can be downloaded to the cellular phones over a network, for instance a wireless network.

### CROSS-REFERENCE TO RELATED APPLICATIONS

This Application is a Non-Provisional of Provisional (35 USC 119(e)) application 60/553,227 filed on Mar. 15, 2004 and Provisional (35 USC 119(e)) application 60/553,226 filed on Mar. 15, 2004.

### BACKGROUND OF THE INVENTION

The inventive arrangements relate generally to cellular phones and more particularly to the remote control of the operation of cellular phones with automatic location identification capabilities.

In June 1996, the Federal Communications Commission (FCC) set in place a two-phase plan for implementing wireless 911 in the United States. Phase I, which was originally to have been implemented by April 1998, required callback numbers and cell site sector information about each incoming wireless 911 call. Cell phones that met the Phase I requirements provided a general indication of the caller's location, although the area may be as large as 100 square miles.

Phase II, which was originally scheduled to have been implemented by October 2001, required wireless carriers to provide automatic location identification (ALI) for each wireless 911 call. The plan included a requirement to provide wireless location accuracy for 95% of the callers within a radius of 150 meters or better. The Phase II portion of the plan was intended to enable improved emergency response in connection with 911 calls. The ALI technology necessary to implement Phase II has been delayed in many instances, but is now being deployed in various locations with the expected improvement in emergency response.

There are two basic methods by which wireless position information can be determined. One approach determines a cell phone position by measuring angle of arrival (AOA) and time of arrival (TOA) of cell phone signals at multiple fixed base stations. This approach is essentially a network-based solution. Still, there are a number of problems associated with such network-based solutions. These problems are mainly related to the vagaries of signal propagation, base station availability and infrastructure costs. An alternative approach makes use of the existing global positioning system (GPS) infrastructure. The GPS based approach incorporates a GPS system into each cell phone and relies upon the phone to determine its location for itself. GPS based systems have their own set of problems that mainly relate to GPS satellite acquisition and cold start delays.

The most advanced ALI systems are those that rely on a combination of both the network based and GPS based solutions. Such systems collect GPS measurements and network measurements and send the measurement data to the position determination entity. The position determination entity then processes the measurements to produce the most accurate location information based on available data.

Currently, ALI technology is commercially available from a number of different technology developers. For example, Qualcomm, Inc. of San Diego, Calif. and SnapTrack, Inc. of Campbell, Calif. offer commercially proven GPS-based positioning solutions for third generation wireless (3G). These systems are available for a variety of different air interfaces including CDMA and GSM. Further, they offer commercially available chipsets that can be integrated in cell phones. Also, rather than requiring modification of each base station, a database is constructed at a position determination entity that contains the precise location of each base station.

Aside from the obvious benefits ALI offers with regard to improving emergency responsiveness, the new technology has also created many opportunities for new and interesting applications that make use of the ALI data. These applications offer revenue-generating products and services that are of potential interest to a range of markets including entertainment, fleet management, and security.

### BRIEF SUMMARY OF THE INVENTION

The present invention relates to a method for providing security features for a cellular phone. The method includes the step of authorizing administrator changes to location identification settings associated with the cellular phone. Location identification options then can be received from the administrator for the cellular phone and at least one location identification rule can be defined that is based upon the received location identification option selections. Finally, at least one security feature can be provided to prevent an unauthorized user from changing the location identification settings. The defined location identification rules can be stored in the cellular phone or in a server.

In one arrangement, control of the location identification settings can be asserted from a centralized location remote from the cellular phone, such as a company home office. The location identification settings can be downloaded to the cellular phones over a network, for instance a wireless network. Accordingly, the administrator can conveniently control the location identification settings for cellular phones associated with an entire pool of employee cellular phones. Moreover, security features can be provided so that the cellular phones can be resistant to tampering by unauthorized persons. In particular, a desired control relates to privacy; denying an entity the ability to track a cellular phone, selectable privacy options for establishing location identification rules can be presented to a user or an administrator of a particular cellular phone. Rules can be established which are applicable to all attempts that are made to track the cellular phone and/or rules can be established which are applicable to certain entities attempting to track the cellular phone. The entities can be individual, groups or certain location identification systems.

### BRIEF DESCRIPTION OF THE DRAWINGS

FIG. 1 is a Schematic drawing showing the operation of a wireless automatic location identification (ALI) system in accordance with the invention;

FIG. 2 is a flow chart of the privacy method in accordance with the invention;

FIG. 3 is a front elevation view of a cellular phone showing a screenshot in accordance with the invention;

FIG. 4 is a front elevation view of a cellular phone showing a second screenshot in accordance with the invention;

FIG. 5 is a front elevation view of a cellular phone showing a third screenshot in accordance with the invention;

FIG. 6 is a front elevation view of a cellular phone showing a fourth screenshot in accordance with the invention;

FIG. 7 is a front elevation view of a cellular phone showing a fifth screenshot in accordance with the invention;

FIG. 8 is a front elevation view of a cellular phone showing a sixth screenshot in accordance with the invention;

FIG. 9 is a flow chart showing the process for location authorization in accordance with the invention;

FIG. 10 is a flow chart for determining location in accordance with the invention; and

FIG. 11 is a front elevation view of a cellular phone having a seventh screenshot in accordance with the invention.

### DETAILED DESCRIPTION OF THE INVENTION

The present invention relates to a method for implementing security features for a telephone automatic location identification (ALI) system. Such security features can be applied to one or more cellular phones, for example cellular phones in a workforce environment. In particular, an administrator can define and implement location identification rules that are applicable to one or more cellular phones. The location identification rules can be programmed directly into the cellular phones by the administrator, programmed into a location identification system server, or entered via a user terminal and downloaded to the one or more cellular phones. Regardless of where and how the location identification rules are stored, security features can be provided to prevent rule additions, changes or deletions by anyone other than an authorized administrator. Accordingly, authorized administrators can maintain control over the location identification features of the one or more cellular phones. In one arrangement, the control can be asserted from a centralized location remote from the cellular phone, such as a home office or an administrator's cellular phone. Accordingly, the administrator can conveniently control the location identification settings for cellular phones associated with an entire pool of employees. Moreover, security features can be provided so that the cellular phones can be resistant to tampering by unauthorized persons.

A preferred setting is the establishment of privacy rules, which are applicable to location identification of a cellular phone. In particular, privacy rules can be established for determining how location identification functions of an automatic location identification (ALI) system are applied to cellular phones. More particularly, selectable privacy options for establishing location identification rules can be presented to a user or an administrator of a particular cellular phone. For example, rules can be established which are applicable to all attempts that are made to identify a location of the cellular phone and/or rules can be established which are applicable to certain entities attempting to identify the location of the cellular phone. The entities can be individuals, groups or certain location identification systems.

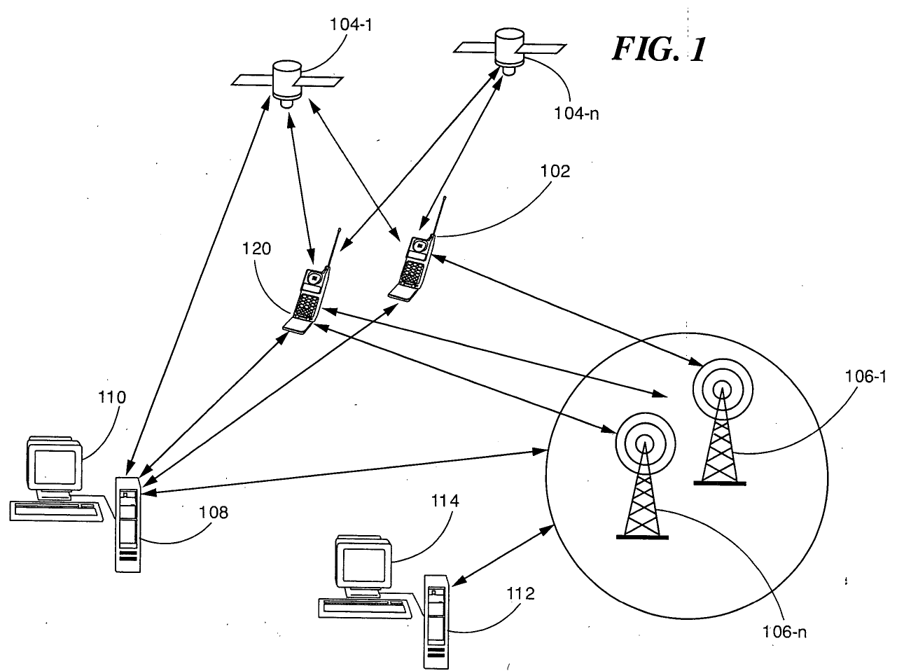

FIG. 1 is a drawing that is useful for understanding the operation of a wireless automatic location identification system in accordance with the inventive arrangements. As illustrated therein, an ALI system can rely on a combination of both network based and GPS based solutions. Such systems collect GPS measurements and network measurements and send the measurement data to a position determination entity. A server can then process the measurements to produce the most accurate location information based on available data.

More particularly, FIG. 1 shows that a conventional network based ALI solution can automatically identify a physical location of a cellular phone 102 by measuring angle of arrival (AOA) and time of arrival (TOA) of cell phone signals at multiple fixed base stations 106-1, 106-n. The cellular phone 102 can be a wireless PDA, cell phone, laptop computer, or any other device incorporating suitable processing and communication circuitry. The fixed base stations 106-1, 106-n can be in communication with a server 108, which can calculate a physical location of the cellular phone 102. For example, the physical location can be calculated based on AOA and TOA information.

The server 108 can communicate with the base stations 106-1, 106-n using any suitable means. For example, a conventional telephone network, high-speed data line, wireless link, or a combination of the foregoing can be used. Base stations 106-1, 106-n can provide a data link between the cellular phone 102 and the server 108. The server 108 can be controlled by a workstation 110 or similar user interface device.

Due to the vagaries of signal propagation, base station availability and other infrastructure limitations, the physical location determined using the network-based solution can be inaccurate in certain instances. In order to improve overall accuracy, the network-based approach can also generate location information for the cellular phone 102 using an alternative approach. For example, the cellular phone can include an onboard global positioning system (GPS) and associated processing circuitry/software. The GPS system can be incorporated into each cellular phone 102 and such system can use signals from a plurality of GPS satellites 104-1, 104-n to independently determine the physical location of the device. The GPS based location information thus obtained can be forwarded to the server 108 through the one or more base stations 106-1, 106-n. Likewise, server 108 can communicate location information to an emergency or 911 services operator. The ALI data provided by the server can be highly accurate data regarding the location of the cellular phone 102 based on a combination of the network data and GPS data.

For the purposes of the present invention, the precise manner by which ALI information is determined is not critical. The system can rely primarily on GPS, network measurements or a combination of the two. Accordingly, the foregoing description represents merely one possible method by which such ALI can be determined. Other methods are also possible and are also intended to be within the scope of the invention.

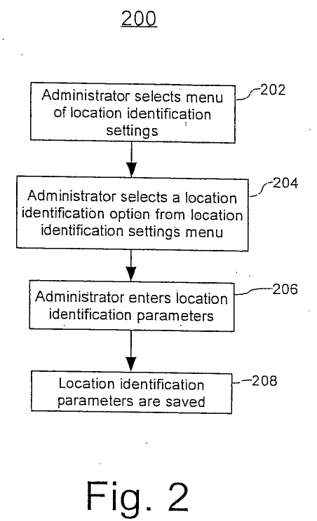

FIG. 2 is a flow chart 200 that is useful for understanding the process of the present invention. As described, certain of the options can be programmed directly into cellular phone 102. However, the invention is not limited in this regard. Instead, the commands or functionality can be entered into other systems as well, for instance a server 108 or application server 112 which processes control requests.

The process in FIG. 2 can begin in step 202 when an administrator selects a menu of location identification options. Referring again to FIG. 1, the menu can be presented on either controlling mobile device 102, or the monitored device 120, the workstation 110, a workstation 114, or any other device having a suitable user interface. Importantly, the workstations 110, 114 or other suitable user interface, such as a second cellular phone 102, can be remote from the cellular phone 102, for example being located at a company home office or other centralized location having a communications link to the cellular phone.

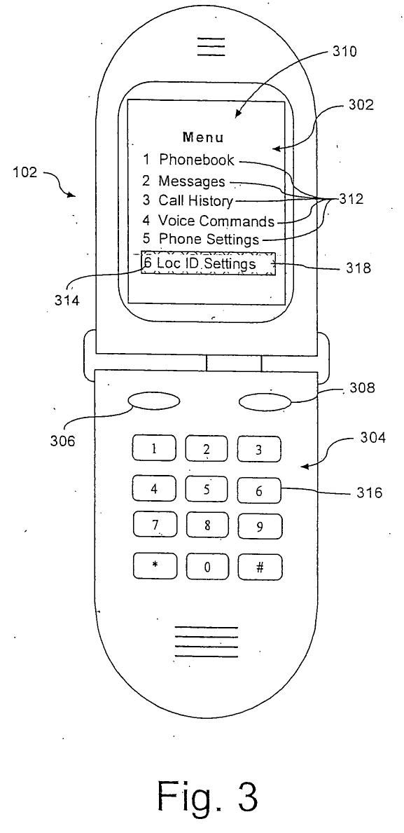

Step 202 can be better understood with reference to FIG. 3. FIG. 3 shows the cellular phone 102, which can have a display 302, a keypad 304, and menu navigation keys 306, 308. The display 302 can be a touch screen display or any other type of display which can present a graphical user interface. Such screens are known to the skilled artisan. In one arrangement, the display 302 can present to an administrator a menu 310 including selectable icons 312 that can be selected using a curser or by touching the display with a stylus or human appendage, such as a finger. In another arrangement, the menu navigation keys 306, 308 can be used to navigate the menu 310 and make a menu selection. In yet another arrangement, each icon 312 in the menu 310 can be identified with a number 314 identifying a corresponding key number corresponding to a key 316 on the keypad 304. In any case, the process can begin in step 202 by a keystroke or touching of the touch screen display 302. One icon 318 from the menu 310 can be selected to present a location identification settings menu. A user interface which enables a location identification settings menu to be provided also can be presented at a second, controlling cellular phone 102, on the workstation 110 and/or workstation 114.

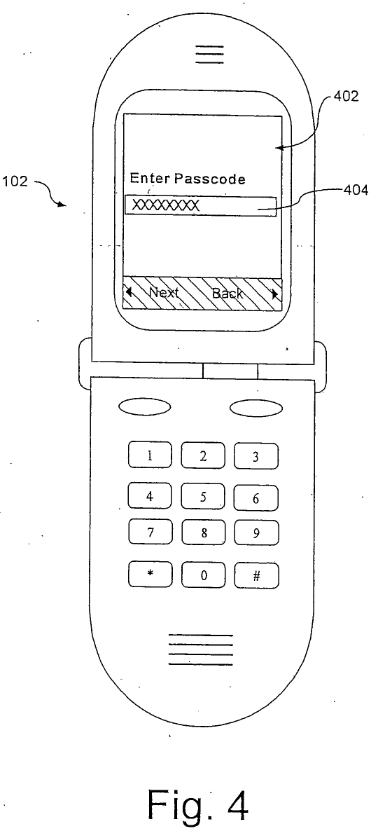

Security features can be incorporated into the cellular phone 102 and/or workstation to prevent unauthorized changes to the location identification settings of the cellular phone. For example, after the icon 318 is selected, a display screen 402 can be presented which prompts the administrator to enter a pass code, as shown in FIG. 4. For example, a character entry field 404 can be provided in the display screen 402. The pass code can comprise characters, such as text, numbers, or any other characters that can be entered into the cellular phone 102. The characters can be entered via the keypad 304. Alternatively, characters can be presented as selectable icons in, and selected from, the display screen 402.

In another arrangement, the workstation 110 or 114 that is used to enter location identification parameters can be a secured workstation. For instance, the workstation 114 can be pass code protected or protected by any other type of security system. For instance, an optical scanner or finger print identifier can be used to verify the identity of an administrator prior to allowing the administrator access to the location identification setting menus.

In yet another arrangement, an application specific processing device (not shown) can be used to update location identification settings in the cellular phone 102 or the server 108 or 112. In such an instance, a communication interface can be provided to enable communication between the application specific processing device 102 and the cellular phone 120 or server 112. For example, a communications port can be provided. Communications ports are known to the skilled artisan.

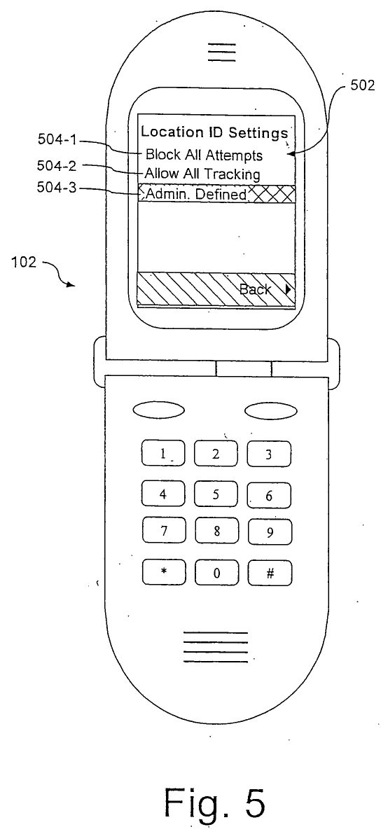

Referring to FIG. 5, the menu 502 of selectable location identification options 504 then can be presented. The menu can include, for example, an option 504-1 for blocking all attempts to identify the location of the cellular phone 120. An option 504-2 can be provided for responding to all location identification requests by providing the requested location information. Another available option can be an option 504-3 to accept administrator defined location identification settings. The options discussed herein are examples of options that can be provided, however, it should be noted the invention is not limited to these specific examples and other location identification options can be provided within the scope of the present invention.

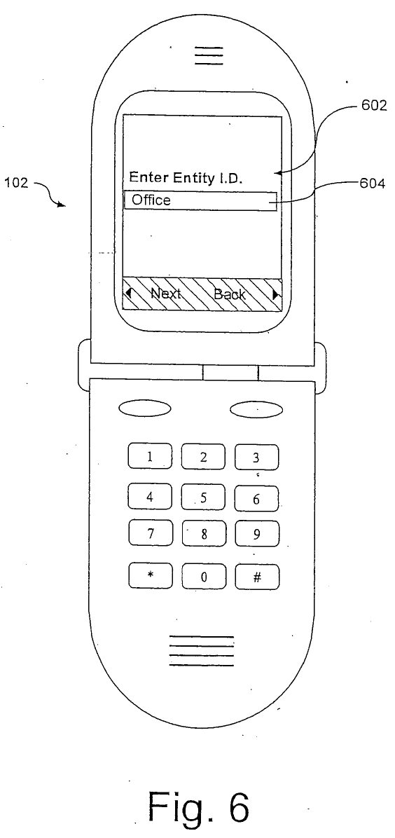

Proceeding to step 204, the administrator can select a location identification option from the location identification settings menu. For example, again making reference to FIG. 5, the administrator can select the “Admin. Defined” option 504-3 from the menu 504. Responsive to the “Admin. Defined” selection, a display screen 602, as shown in FIG. 6, can be presented to the administrator to prompt the administrator to enter an identifier for a control entity to which the location identification rule will apply. For instance, a character entry field 604 can be provided in the display screen 602. Once entered, this information may be stored at server 114 or either cellular phone 120 (target phone) or 102 (control phone). Therein the administrator can enter characters identifying the entity to which the administrator-defined rule being created will apply such as providing access from the administration office. In another arrangement, a list of known entities can be presented from which the administrator can select an entity. Still, any other suitable means for identifying an entity can be used.

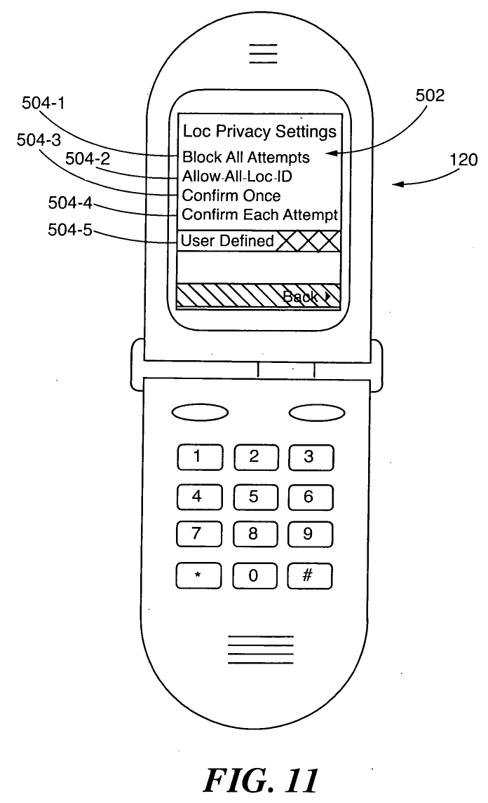

Another available option in one embodiment can be an option 504-3 as seen in FIG. 11, for the cellular phone user to set their own user-defined privacy settings. In this option, a user is prompted once by server 112 with a location identification request. The user verifies that the location information of the cellular phone 120 can be made available to a particular entity making the request. If the user negatively responds, all location identification to that entity can be blocked by server 112 which has stored the preference in a database. However, if the user positively responds, then all location identification by the entity, including location identification at future times, can be allowed by server 112 until the user selects otherwise. If the user does not respond to the location identification request prompt, location identification by the entity can be blocked and the user can be prompted again by server 112 the next time that the entity requests a location identifier for the cellular phone 120. Option 504-4 requires each location identification attempt to be confirmed by the user to be allowed. Finally, an option 504-5 to accept user defined location identification settings can be provided. The options discussed herein are examples of options that can be provided, however, it should be noted the invention is not limited to these specific examples and other privacy options can be provided within the scope of the present invention.

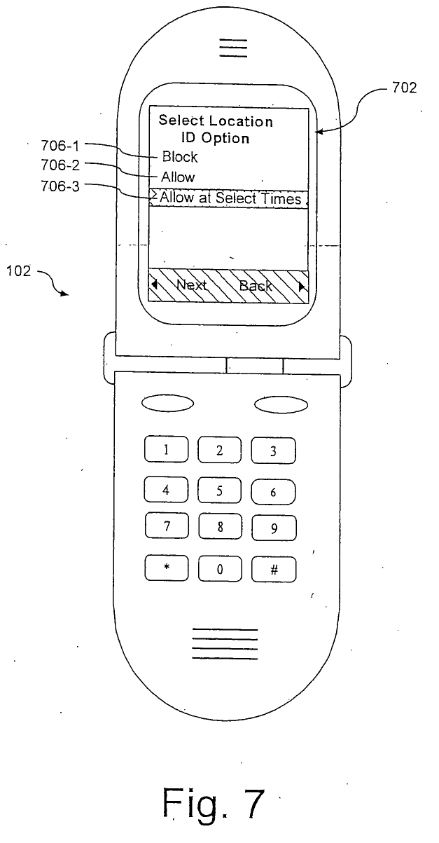

Continuing at step 206, the administrator then can enter location identification option parameters. Step 206 can be better understood by making reference to FIG. 7. A display screen 702 can be presented which lists options 706 from which the administrator can choose. As with the FIG. 11, a “Block” option 706-1 can be provided to block all location identification attempts from the identified entity. An “Allow” option 706-2 can be provided if it is desired to provide location information for each location identification request received from the identified entity. Also, an “Allow at Select Times” option 706-3 can be provided to allow the administrator to establish select times at which the identified entity can receive location identification information for the cellular phone 120.

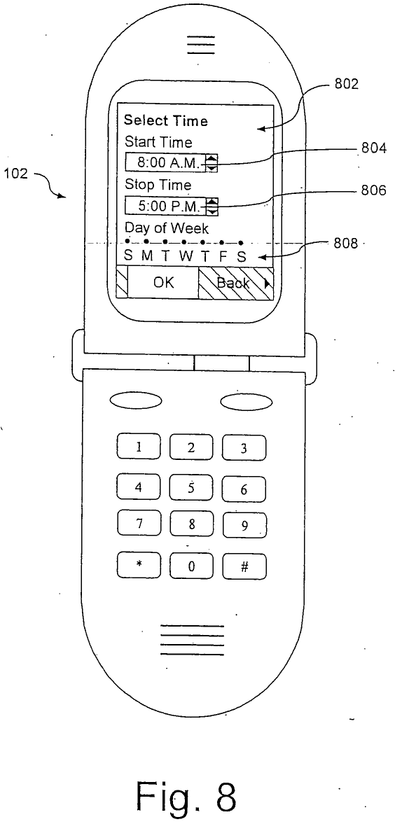

If the “Allow at Select Times” option 706-3 is selected, a display screen 802, shown in FIG. 8, can be presented in which the administrator can define times when the identified control entity can receive the location identification information for the cellular phone 102. For example, the administrator can be prompted to enter a start time 804, a stop time 806, a day of week 808, or any other identifier that can be used to define a time frame. At this point it should be noted that the menus presented herein are merely examples of menus that can be provided, and the invention is not so limited. Moreover, such menus have been provided in the context of being presented on a cellular phone 102, but the menus also can be presented on a workstation such as workstation 114 or any other suitable device.

Once the location identification parameters have been entered, the location identification parameters can be saved, as shown in step 208 of FIG. 2. The parameters can be saved to the cellular phone 102, phone 120, the database at server 112, or any other suitable device.

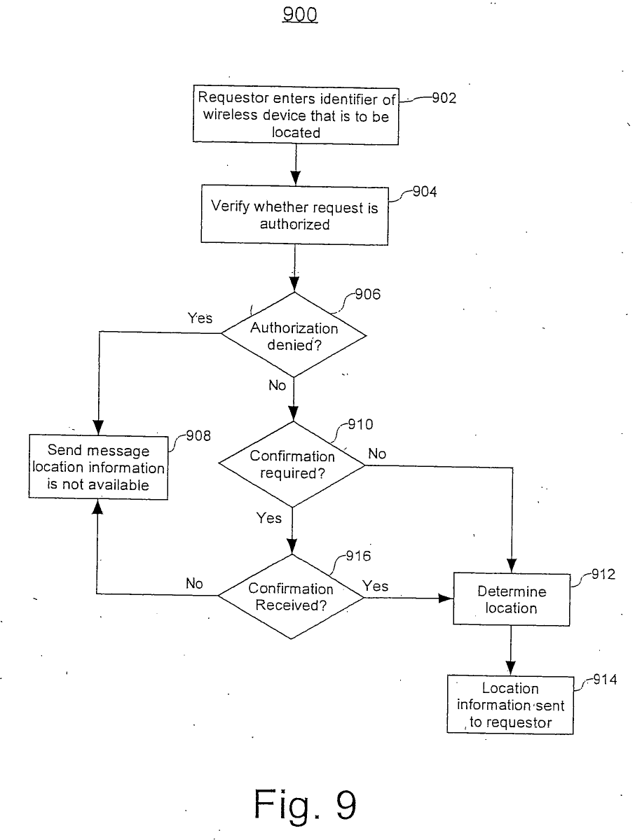

Referring to FIG. 9, a flowchart 900, which is useful for understanding another aspect of the invention, is presented. In particular, the flow chart 900 describes a process by which a request by an entity (requestor) requesting a location of the cellular phone 120 can be processed. Beginning at step 902, the requestor can enter an identifier associated with a cellular phone 120 that the requestor wishes to be tracked. For example, the requestor can enter a telephone number associated with the cellular phone 102, a serial number of the cellular phone 120, or any other identifier that can be used to uniquely identify the cellular phone 120. The identifier can be propagated to a server 112 or other computing device which is suitable for processing location identification requests.

Proceeding to step 904, server 112, utilizing data either at its own database or data stored from either cellular phone 120, can verify whether the request is authorized. For example, server 112 can determine (1) whether the location identification attempts by the administrator requestor are allowed or blocked, (2) whether there are limitations on the location identification attempts by the requestor, such as times when location identification is not allowed, or (3) any other limitations that may be applicable to the requestor as discussed above by comparing the entered identifier and the stored preferences. Continuing at step 906, if authorization is denied, a message can be propagated to the requester, either at a requestor cellular phone 102 or a requestor workstation 114 informing the requestor that the location information is not available, as shown in step 908.

If authorization has not been denied, the process can proceed to step 910. If a confirmation is not required from the cellular phone 102 to be tracked, the location of the cellular phone 120 can be determined by server 108 and the location information can be sent to the requestor at server 112 or cell phone 102, as shown in steps 912 and 914. However, if a confirmation is required, server 112 can process the location identification request once a positive confirmation is received, as shown in step 916 and steps 912 and 914. If a negative response is received from the cellular phone 120, or no confirmation is received within a predetermined time after the request, a message can be sent by server 112 informing the requestor that the location information is not available, as shown in step 908.

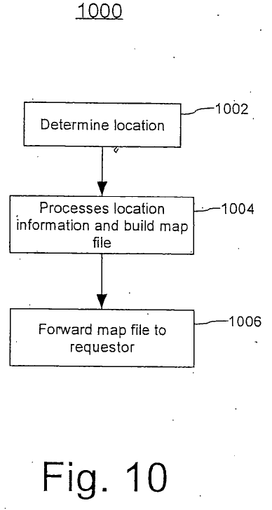

Referring to FIG. 10, a flow chart 1000 is presented which shows one example of a process that can be used to provide location information to a requestor. Beginning at step 1002, after receiving an authorized location identification request, the server 112 can with server 108 determine the location of the cellular phone 120 being tracked, as previously described. The server 112 can process the location information and build a map file, as shown in step 1004. The map file can include the location of the cellular phone 120, but also can include other points of interest as well. The map file then can be sent to the requester, as shown in step 1006. In one arrangement, a notification first can be sent to the requestor informing the requestor that a map file is available for viewing. The requester then can request to view the map file and the map file can be presented to the requestor.

The location identification options can be applied when an attempt is made to identify the location of the cellular phone 120. In the case that the location identification parameters are added or edited using either cellular phone 102 or 120, the parameters can be saved directly by the cellular phones 102, 120, or uploaded to the server 112 or another suitable device. In the case the parameters are added or edited by the workstation 114, the parameters can be stored on the server 112 or downloaded to the cellular phones 102, 120, via the communications link. Advantageously, location identification parameters can be created or edited and downloaded to multiple cellular phones simultaneously. Accordingly, cellular phones 120 carried by an entire pool of employees can be conveniently updated.

When the parameters are stored on the cellular phone 120, the location identification rules with which the parameters are associated can be applied by the cellular phone 120 as operated upon by server 112. Importantly, the location identification rules can be secured within the cellular phone 120 to prevent tampering or rule changes by an unauthorized person, such as a user of the cellular phone. The location identification rules can also be downloaded to the cellular phone 120 via a workstation 114, server 112, or other suitable application specific device. Such devices can incorporate security features to prevent unauthorized changes in the location identification rules. Moreover, when a workstation, server, or other suitable application specific device is used to download location identification rules to the cellular phone 120, the location identification settings menu can be disabled on the cellular phone 120 to block unauthorized rule changes. In another arrangement, the cellular phone 120 can be provided without the location identification settings menu.

When the parameters are stored to the server 112, the location identification rules associated with the parameters can be applied to the server 112 and/or applied by the server 112. Still, the invention is not limited in this regard and the location identification rules can be applied by any other suitable device. Again, the location identification settings menu can be disabled on the cellular phone or not provided at all. Further, the server 112 can include security features to prevent location identification rule changes by unauthorized entities.

The above embodiment was described in connection with a first server 108 forming part of the network for determining the location of the cellular phone 120, preferably a cellular phone and a second server 112 for performing the application. It should realized that it is well within the scope of the invention for a single server to perform both functions.

While the preferred embodiments of the invention have been illustrated and described, it will be clear that the invention is not so limited. Numerous modifications, changes, variations, substitutions and equivalents will occur to those skilled in the art without departing from the spirit and scope of the present invention as described in the claims.

1. A method for providing selectable privacy options for reporting the location of a cellular phone to a remote device comprising:
providing an input to select a privacy option at a remote device;
receiving said input and associating parameters with the selected privacy option to define a location identification rule associated with said cellular phone; and
applying the defined location identification rule to attempts that are made to identify the physical location of the cellular phone.

2. The method of claim 1, wherein said input is a user input.

3. The method of claim 2, further comprising the step of storing the defined location identification rules in the cellular phone.

4. The method of claim 1, wherein said input is selected by an entity at the remote device.

5. The method of claim 4, further comprising the step of storing the defined location identification rules at the remote device.

6. The method of claim 1, wherein the privacy option is selected from the group consisting of a block of all location identification attempts option, allow all location attempts option, a confirm location identification allowed once option, a confirm each location identification attempt option, and a user defined option.

7. The method of claim 2, further comprising the step of receiving a pass code at the cellular phone, from the user, the pass code being required to be entered at said cellular phone to enter a privacy option.

8. The method of claim 4, further comprising the step of receiving a pass code from the entity, the pass code being required to be entered at a server to enter privacy options

9. The method of claim 4, wherein said input is from a second cellular phone.

10. The method of claim 4, further comprising the step of storing the defined location in one of said cellular phone and said second cellular phone.

11. The method of claim 4, wherein said remote device is a server.
